(19) United States
(12) Patent Application Publication
(10) Pub. No.: US 2011/0095201 A1
(43) Pub. Date: Apr. 28, 2011

(54) Electrowetting sample presentation device for matrix-assisted laser desorption/ionization mass spectrometry and related methods

(76) Inventor: Mark L. Stolowitz, Pleasanton, CA (US)

(21) Appl. No.: 10/569,223

(22) PCT Filed: Aug. 20, 2004
(86) PCT No.: PCT/US04/27377

§ 371 Date: Apr. 28, 2009

Related U.S. Application Data
(60) Provisional application No. 60/497,223, filed on Aug. 22, 2003.

(51) Int. Cl. G01N 21/01

(52) U.S. Cl. 250/428

(57) ABSTRACT

Electro-wettable sample presentation devices are useful in performing analytical measurements such as the detection of analytes contained within a liquid sample drop. The device comprises a virtual microwell for receiving a liquid sample drop; one or more intermediary electro-wettable sites at least one of which is contiguous to the microwell; and a terminal electro-wettable site which confines the deposition of analytes and matrix to within a predetermined area. The microwell is either an electro-wettable zone or a chemically-modified zone which exhibits either hydrophobic and non-adsorptive properties with respect to analytes, or hydrophobic and adsorptive properties with respect to analytes. Each of the electro-wettable sites modifies the surface of the sample presentation device between hydrophobic and hydrophilic states in response to an electrical potential applied between a liquid sample drop and the electro-wettable site so as to direct the positioning of the liquid sample drop.

### TECHNICAL FIELD

The present invention relates to the field of matrix-assisted laser desorption/ionization time-of-flight mass spectrometry (MALDI-TOF-MS). More particularly, the present invention relates to sample preparation devices and methods for use in matrix-assisted laser desorption/ionization mass spectrometry with improved analytical detection capabilities.

### BACKGROUND OF THE INVENTION

Matrix-assisted laser desorption/ionization time-of-flight mass spectrometry is an important analytical tool in proteomics efforts, in that they are dependent upon the ability to rapidly analyze minute quantities of peptide and protein mixtures. Large scale proteomics applications require high sensitivity detection and high sample throughput at moderate cost. These demands underscore the importance of sample preparation and automated data acquisition. In MALDI-TOF-MS, analytes are mixed with a matrix solution in an appropriate solvent and deposited on the surface of a sample support (also referred to as plate or target) for subsequent drying and crystallization. During the course of drying, crystal growth is induced and analyte molecules become co-crystallized with the matrix. The MALDI-TOF-MS sample support is then inserted into a mass spectrometer and a relatively small diameter (e.g. 100 μm) laser beam is directed onto the sample. Photon bombardment causes the analyte and matrix molecules to be desorbed and ionized without substantial fragmentation. The desorbed ions are then mass analyzed in the mass spectrometer. The matrix is an energy absorbing substance which absorbs energy from the laser beam thereby enabling desorption of analytes from the sample support.

Present day MALDI-TOF-MS sample supports suffer from a severe limitation with respect to the liquid sample volume which may be applied to the support. Volumes in the range 0.5 to 3.0 μL are routinely utilized and afford dried-droplets containing analytes and matrix having diameters of from 1 to 2 mm. As a result, only a minute portion of the dried-droplet is irradiated by the laser during single-site data acquisition. Unfortunately, even small volumes of less than 3.0 μL are known to result in sample heterogeneity, which gives rise to significant variations in peak intensity, resolution and mass accuracy when focusing the laser on different regions of the dried-droplet (Strupat, K.; Karas, M.; Hillenkamp, F. Int'l. J. Mass Spectrom. Ion Processes, 1991, 111, 89-102; Cohen, S. L. and Chait, B. T. Anal. Chem., 1996, 68, 31-37; and Amado, F. M. L.; Domingues, P.; Santana-Marques, M. G.; Ferrer-Correia, A. J.; Tomer, K. B. Rapid Commun. Mass Spectrom., 1997, 11, 1347-1352, all of which are incorporated herein by reference).

Sample heterogeneity results from differential precipitation of analytes which occurs during drying. Volatile organic solvent present in the liquid sample drop rapidly evaporate during drying which renders specific analytes insoluble. These phenomena render necessary the critical inspection of the mass spectral data as well as the accumulation of a large number of single-site spectra per sample. Consequently, only a few hundred samples can be analyzed per instrument per day, and automated data acquisition is often precluded.

The problem of sample heterogeneity can be overcome or significantly reduced if the spot diameter falls below 250 μm. In this instance, a large portion of the sample can be irradiated simultaneously, improving sensitivity and reproducibility (Little, D. P.; Cornish, T. J.; ODonnell, M. J.; Braun, A.; Cotter, R. J.; Koster, H. Proc. Natl. Acad. Sci. U.S.A., 1997, 69, 4540-4546; and Gobom, J.; Nordhoff, E.; Mirgorodskaya, E.; Ekman, R.; Roepstorff, P. J. Mass Spectrom., 1999, 34, 105-116, incorporated herein by reference).

Peptide and protein samples purified by conventional liquid chromatographic and electrophoretic methods are routinely recovered in volumes of from 5 to 10 μL, necessitating their concentration prior to MALDI-MS. Furthermore, many samples contain detergents and salts that interfere with mass spectral analyses and must be removed. To address these concerns, researchers have prepared micro-columns for sample concentration and desalting by packing small pipette tips with reverse phase chromatographic media (Rusconi, F.; Schmitter, J.-M.; Rossier, J.; le Maire, M. Anal. Chem., 1998, 70, 3046-3052, incorporated herein by reference). Analytes are routinely recovered from micro-columns in volumes of from 5 to 10 μL, and a portion of the eluant is deposited onto the mass spectrometer sample support. The popularity of micro-column approaches prompted improvements in their design which modestly reduced the volume of eluant required to recover analytes to approximately 5 μL (U.S. Pat. Nos. 6,048,457 and 6,200,474, incorporated herein by reference). Micro-columns for MALDI-TOF-MS sample preparation are commercially available as ZipTips® from Millipore Corporation. However, the use of either ZipTips® or home-made micro-columns is time consuming, adds considerable cost, has proven difficult to automate and often affords only moderate (40 to 60%) recoveries of sample material. Nevertheless, micro-column approaches are routinely utilized to reduce sample volumes prior to MALDI-TOF-MS.

Some of the limitations associated with the dried-droplet approach have been addressed, at least in part, by the MALDI-TOF-MS sample supports described in U.S. Pat. No. 6,287,872, incorporated herein by reference. These sample supports are coated with a thin layer of nonwettable hydrophobic material that carries an array of 200 μm diameter wettable hydrophilic spots. The invention exploits the “anchoring” attributes of the hydrophilic spots to direct the deposition of analytes to within an area with a diameter of less than 250 μm. Aspects of the aforementioned sample supports are further described in two reports (Schüerenberg, M.; Lubbert, C.; Eickhoff, H.; Kalkum, M.; Lehrach, H; Nordhoff, E. Anal. Chem. 2000, 72, 3436-3442; and Nordhoff, E.; Schüuerenberg, M.; Thiele, G.; Lübbert, C.; Kleoppel, K.-D.; Theiss, D.; Lehrach, H. and Gobom, J. Intl. Journal Mass Spectrometry 2003, 226, 163-180, both of which are incorporated herein by reference). These reports conclude that confining the deposition of analytes to a small spot diameter not only reduces problems associated with sample hetero-geneity, but also results in a significant increase in sensitivity of detection.

Sample supports which exploit small hydrophilic anchors are commercially available as the Anchor Chip™ from Bruker Daltronics GmbH. Unfortunately; the manufacturer recommends that relatively large anchors of either 400 μm or 600 μm diameter be utilized for proteomics-related applications (Anchor Chip™ Technology, Revision 1.6, Bruker Daltronics GmbH, November 2000, incorporated herein by reference). Consequently, many of the difficulties outlined above regarding sample heterogeneity remain unaddressed. A further limitation associated with the use of the Anchor Chip™ is the requirement that the volume of liquid sample applied to each anchor be limited to from 0.5 to 3.0 μL (No. 1 of Eleven General Rules for Sample Preparation on Anchor Chip™ Targets). Examples provided by the manufacturer recommend yet further limiting the liquid sample drop volume to either 0.5 or 1.0 μL (which is mixed with 2.0 μL of matrix solution prior to deposition on the Anchor Chip™). Additionally, it is required that the sample first be purified and concentrated on a ZipTip® prior to application. Therefore, although still representing an improvement of sorts, the Anchor Chip™ suffers many of the same limitations associated with other present day MALDI-TOF-MS sample supports.

The general concept of exploiting wettable hydrophilic regions in conjunction with non-wettable hydrophobic films to confine samples to predetermined locations is described in U.S. Pat. Nos. 5,041,266; 5,831,184; 5,958,345; and 6,555,813, all of which are incorporated herein by reference.

Collectively, present day MALDI-TOF-MS sample supports suffer from a severe sample volume limitation, in that they are incompatible with sample volumes in excess of 3 μL. This volume is significantly smaller than the volume in which samples are routinely recovered from chromatographic or electrophoretic purifications, necessitating their further concentration prior to MALDI-TOF-MS. Furthermore, even volumes as small as 3 μL can prove problematic owing to sample heterogeneity when the dried-droplet approach is utilized. Although the Anchor Chip™ addresses some of the problems associated with sample heterogeneity by reducing the sample spot size, it suffers from the same liquid sample volume constraints as other present day sample supports.

In recent years, the principle of electrowetting-on-dielectric (EWOD) has attracted considerable interest for microscale liquid handling (see, e.g., Washizu, M., IEEE Transactions on Industry Applications (1998) 34(4), 732-737; Pollack, M. G., Fair, R. B. and Shenderov, A. D., Applied Physics Letters (2000) 77(11), 1725-1726; and Lee, J., Moon, H., Fowler, J., Schoellhammer, T. and Kim, C.-J., Sensors and Actuators A (2002) 95, 259-268). In electrowetting-on-dielectric, a droplet rests on a surface or in a channel coated with a hydrophobic material. The surface is modified from hydrophobic to hydrophilic by applying a voltage between the liquid droplet and an electrode residing under a hydrophobic dielectric surface layer. Charge accumulates at the liquid-solid interface, leading to an increase in surface wettability and a concomitant decrease in the liquid-solid contact angle. By changing the wettability of each of the electrodes patterned on a substrate, liquid drops can be shaped and driven along a series of adjacent electrodes, making microscale liquid handling extremely simple both with respect to device fabrication and operation. Several unit operations involving creating, transporting, cutting, and merging liquid droplets by electrowetting-based actuation have been demonstrated (Cho, S. K., Moon, H. and Kim, C.-J., J. Microelectromechanical Systems (2003) 12(1), 70-80).

Electrowetting-on-dielectric (EWOD) offers the following advantages over alternative microfluidic approaches: (1) EWOD does not require that soluble or particulate analytes be charged or have large polarizabilities; (2) the power required to transport liquid droplets is much lower than in micropumping or electrophoresis-based devices; (3) EWOD-based devices require no moving parts; and (4) EWOD-based devices can be reconfigured simply by reprogramming the sequence of applied potentials. Furthermore, because the liquid is not in direct contact with the electrodes, electrolysis and analyte oxidation-reduction reactions are avoided.

Exemplary electrowetting-on-dielectric devices for liquid droplet manipulation are disclosed in U.S. Pat. No. 6,565,727, issued May 20, 2003; U.S. patent application Ser. No. 09/943,675, published Apr. 18, 2002; U.S. patent application Ser. No. 10/305,429, published Sep. 4, 2003; U.S. patent application Ser. No. 10/343,261, published Nov. 6, 2003; U.S. Patent Application No. 2004/0031688 A1, published Feb. 19, 2004; U.S. Patent Application No. 2004/0058450 A1, published Mar. 25, 2004; U.S. Patent Application No. 2004/0055536 A1, published Mar. 25, 2004; and U.S. Patent Application No. 2004/0055891, published Mar. 25, 2004; all of which are incorporated herein by reference in their entirety.

Recently, methods for the minimization of biomolecular adsorption during electrowetting-on-dielectric-based liquid droplet manipulation of peptide- and protein-containing solutions were described (Jeong-Yeol, Y. and Garrell, R. L., Anal. Chem. (2003) 75: 5097-5102) and, very recently, compatibility of electrowetting-on-dielectric devices with MALDI-TOF-MS was reported (Wheeler, A. R., Moon, H., Kim, C.-J., Loo, J. A. and Garrell, R. L., Anal. Chem. (2004) 76: 48334838). Never-the-less, the aforementioned report failed to address the many limitations enumerated above, in that the manipulation of volumes greater than 0.5 μL was not addressed.

Therefore, a need exists for a sample presentation device for matrix-assisted laser desorption/ionization time-of-flight mass spectrometry that: (1) Is compatible with the sample volumes routinely recovered from liquid chromatographic and electrophoretic separations; (2) Directs the deposition of analytes to within a confined area so as to address those issues which result from sample heterogeneity; (3) Affords an increase in sensitivity of detection; and (4) Facilitates automated acquisition of data. The availability of such a sample presentation device would enable automated sample processing on the life science industry's standard multiwell plate processors and liquid handling robots as well as enable the direct collection and subsequent analysis of chromatographic eluants by MALDI-TOF-MS. Collectively, these capabilities would significantly enhance the throughput of proteomics efforts.

### SUMMARY OF THE INVENTION

It is an object of the present invention to provide a sample presentation device for matrix-assisted laser desorption/ionization mass spectrometry which is optimal with respect to receipt and subsequent positioning of a liquid sample drop.

It is a further object of the present invention to provide a sample presentation device for matrix-assisted laser desorption/ionization mass spectrometry which is optimal with respect to confining the co-deposition of analytes and matrix.

It is another object of the present invention to provide a sample presentation device for matrix-assisted laser desorption/ionization mass spectrometry so as to facilitate the homogeneous co-deposition of analytes and matrix.

It is another object of the present invention to provide a sample presentation device for matrix assisted laser desorption/ionization mass spectrometry that precisely positions co-deposition of analytes and matrix so as to facilitate automated data acquisition.

It is another object of the present invention to provide a sample presentation device for matrix-assisted laser desorption/ionization mass spectrometry which is optimal with respect to high sensitivity detection of analytes.

It is another object of the present invention to provide a sample presentation device for matrix-assisted laser desorption/ionization mass spectrometry that retains liquid sample drop volumes of from less than 0.5 μL to greater than 10 μL, including liquid sample drop volumes greater than 3 μL known to be incompatible with prior art sample supports.

It is another object of the present invention to provide a sample presentation device for matrix-assisted laser desorption/ionization mass spectrometry that retains liquid sample drops on the surface of the sample presentation device without the need for a physical reservoir or well.

It is another object of the present invention to provide a sample presentation device for matrix-assisted laser desorption/ionization mass spectrometry that exhibits a minimum of nonspecific adsorption with respect to analytes.

It is another object of the present invention to provide a sample presentation device for matrix-assisted laser desorption/ionization mass spectrometry that is suitable for the direct collection and subsequent analysis of fractions recovered from high performance liquid chromatographic (HPLC) separations.

It is another object of the present invention to provide a sample presentation device for matrix-assisted laser desorption/ionization mass spectrometry that is suitable for the analysis of enzymatic digests prepared from protein spots excised from 1- and 2-dimensional electrophoresis gels.

It is another object of the present invention to provide a sample presentation device for matrix-assisted laser desorption/ionization mass spectrometry that is suitable for the analysis of samples recovered from surface plasmon resonance (SPR) biosensors.

It is yet another object of the present invention to provide a sample presentation device for matrix-assisted laser desorption/ionization mass spectrometry that is suitable for sample processing on standard multi-well plate processors and laboratory liquid handling robots.

It is still yet another object of the present invention to provide for methods for using and creating the aforementioned devices. More specifically, it is an object of the present invention to use the electrowetting sample presentation devices of the present invention to identify the presence of analytes in a sample, and to analyze a plurality of samples, either on a sample presentation device or on a plurality of sample presentation devices.

The above and other objects of the present invention are realized in specific embodiments of an electrowetting sample presentation device. The novel sample presentation device of the present invention is utilized as a sample collection device to enable receipt of liquid sample drop volumes of from less than 0.5 μL to greater than 10 μL. Volumes greater than about 3 μL are known to be incompatible with prior art sample supports, in that they are known to result in the heterogeneous deposition of analytes with a concomitant reduction in sensitivity of detection and ease of automated data acquisition. The novel sample presentation device of the present invention is further utilized as a precise sample positioning device that confines the co-deposition of analytes and matrix to within a surface area measuring less than about one-half millimeter squared (0.5 mm²). Confining the co-deposition of analytes and matrix is known to facilitate the homogeneous deposition of analytes with a concomitant increase in both ease of automated data acquisition and sensitivity of detection. As a result, the novel electrowetting sample presentation device of the present invention provides optimum utility with respect to liquid sample droplet receipt, sample positioning and confined co-deposition of analytes and matrix. In preferred embodiments, this combination of attributes affords an increase in sensitivity of detection of from about 10-fold to greater than 50-fold, as well as an increase in throughput of at least 10-fold, as compared to prior art sample supports.

The sample presentation device of the present invention is comprised of either an electro-wettable virtual microwell or a patterned zone virtual microwell that can receive a liquid sample drop; one or more intermediary electro-wettable sites at least one of which is contiguous to the virtual microwell; and a terminal electro-wettable site which confines the deposition of analytes and matrix to within a predetermined area. Each of the electro-wettable sites modifies the surface of the sample presentation device between hydrophobic and hydrophilic states in response to an electrical potential applied between a liquid sample drop and the electro-wettable site so as to direct the positioning of the liquid sample drop. Furthermore, with respect to the path which originates at the microwell, the surface area of each succeeding intermediary electro-wettable site is equal to or less than that of the preceding electro-wettable site.

The present invention further provides a sample presentation device having from 2 to 1536 individual sample presentation sites, wherein each sample presentation site is further comprised of a physical or virtual microwell which can receive a liquid sample drop; one or more intermediary electro-wettable sites at least one of which is contiguous to the microwell; and a terminal electro-wettable site which confines the deposition of analytes and matrix to within a predetermined area. The plurality of sample presentation devices may be configured in a manner analogous to Life Science Industry's standard 96, 384 and 1536 multiwell plates, so as to be compatible with standardized multiwell plate processors and laboratory liquid handling robots.

The virtual microwell of the present invention provides a containment which holds a liquid drop when deposited therein. The containment can result either from an actuated electro-wettable zone or a patterned zone exhibiting greater wettability (lower surface tension) than the surrounding area. In the later case, the surface of the microwell of the present invention is chemically-modified so as to exhibit either hydrophobic and non-adsorptive properties with respect to analytes, or hydrophobic and adsorptive properties with respect to analytes. The shape of the microwell may provide for some overlap between the edge of a liquid drop residing therein and one or more contiguous electro-wettable sites so as to facilitate the transfer of a liquid drop to adjacent electro-wettable sites.

Once deposited into the microwell, a liquid sample drop containing dissolved analytes and matrix is allowed to evaporate until the volume of the drop is significantly reduced, and then transferred onto one or more adjacent electro-wettable sites by actuation of the appropriate electrodes. As the liquid drop continues to evaporate, it is repeatedly transferred along a path in which the surface area of each succeeding electro-wettable site is equal to or less than that of the preceding electro-wettable site. Lastly, the liquid sample drop (the volume of which has been significantly reduced owing to evaporation either by ambient conditions or by heating) arrives at the terminal electro-wettable site. As the liquid drop finally dries, analytes are deposited as a homogeneous thin film on the surface of the terminal electro-wettable site. As a result, the sample presentation device of the present invention enables the confined deposition of analytes with a concomitant increase in sensitivity of mass spectrometric detection. Furthermore, unlike prior art sample supports the confined deposition of analytes is to a great extent independent of the initial volume of the liquid sample drop residing within the microwell.

### BRIEF DESCRIPTION OF THE FIGURES

The above and other objects of the present invention will become apparent from consideration of the detailed description presented in connection with the accompanying drawings in which:

FIGS. 1 through 7 depict representative arrangements of the microwell, intermediary electro-wettable sites and terminal electro-wettable site of the sample presentation device of the present invention. FIG. 1 depicts a linear arrangement of electro-wettable sites which exploits wide electrodes. FIGS. 2 and 3 depict a linear arrangement of electro-wettable sites which exploits narrow electrodes. FIG. 4 depicts a non-linear arrangement of electro-wettable sites which exploits wide electrodes. FIGS. 5 and 6 depict an arrangement of electro-wettable sites wherein intermediary electro-wettable sites are contained within the area circumscribed by the electro-wettable site which is contiguous with the microwell. FIG. 7 depicts an arrangement of elliptical electro-wettable sites wherein the virtual microwell is an electro-wettable site.

FIGS. 8A and 8B depict a cross-sectional view of a representative sample presentation device of the present invention which shows the arrangement of the non-conducting substrate, electrodes, dielectric film and hydrophobic thin film surface.

FIGS. 9A and 9B depict a cross-sectional view of a representative sample presentation device of the present invention which shows the arrangement of the non-conducting substrate, electrodes, dielectric film and hydrophobic thin film surface, wherein the area of the first intermediary electrode overlaps the area of the virtual microwell to enable the efficient transfer of the liquid sample drop to the first intermediary electrode.

FIGS. 10A and 10B depict a sample presentation device of the present invention having a plurality of sample presentation sites.

FIG. 11A through 11F depicts a sample presentation device of the present invention configured in the Life Science Industry's standardized 96-well plate format.

FIGS. 12A through 12F depict various electrode arrangements may be exploited for fabrication of the sample preparation device of the present invention.

FIGS. 13A and 13B depict a cross-sectional view of a representative sample presentation device of the present invention which shows the arrangement of the non-conducting substrate, electrodes, dielectric film and hydrophobic thin film surface, wherein a thin metallic grounding electrode is patterned on the thin hydrophobic film surface.

FIGS. 14A and 14B depict a cross-sectional view of a representative sample presentation device of the present invention which shows the arrangement of the non-conducting substrate, electrodes, dielectric film and hydrophobic thin film surface, wherein a thin metallic grounding electrode is patterned between the dielectric film and the hydrophobic thin film surface.

FIGS. 15A through 15D and 16A through 16D illustrate the operation of representative sample preparation devices of the present invention.

### DETAILED DESCRIPTION OF THE INVENTION

### Definitions

Unless defined otherwise, all technical and scientific terms used herein have the meaning commonly understood by a person skilled in the art to which this invention belongs.

“Adsorption” refers to the process by which an analyte is retained on a surface as a consequence of interactions between the analyte and the surface.

“Analytes” refers to one or more components of a sample which are desirably detected.

“Laser desorption/ionization mass spectrometer” refers to a mass spectrometer that utilizes a laser as an ionization source to enable desorption of analytes.

“Mass spectrometer” refers to an apparatus that measures a parameter which can be translated into mass-to-charge ratios (m/z) of ions formed when a sample is ionized into the gas phase.

“Matrix” refers to a molecule that absorbs energy from an ionization source in a mass spectrometer to enhance desorption of analytes from the surface of a sample presentation device. Reagents frequently utilized as matrix for the detection of biological analytes include trans-3,5-dimethoxy-4-hydroxycinnamic acid (sinapinic acid, SA), α-cyano-4-hydroxycinnamic acid (CHCA) and 2,5-dihydroxybenzoic acid (DHBA). Other suitable energy absorbing molecules are known to those skilled in this art.

“Sample presentation device” refers to a device that is insertable into and removable from a mass spectrometer and comprises a substrate having a surface for presenting analytes for detection.

“Sensitivity of detection” refers to the analytical limit at which an analyte can be routinely detected.

“Surface” refers to the exterior or upper boundary of a body or a substrate that contacts the sample.

“Surface tension” refers to a property of liquids in which a liquid drop deposited on a surface tends to contract the smallest possible contact area because of unequal molecular cohesive forces near the surface, measured by the force per unit of length.

“Wettability” refers to the degree to which a solid surface is wetted by a liquid. With respect to water, high-energy surfaces are efficiently wetted and have relatively low contact angles, whereas low-energy surfaces are not wetted and have relatively high contact angles.

### Overview

The sample presentation device of the present invention is comprised of a physical or virtual microwell which can receive a liquid sample drop; one or more intermediary electro-wettable sites at least one of which is contiguous to the microwell; and a terminal electro-wettable site which confines the deposition of analytes and matrix to within a predetermined area. Each of the electro-wettable sites modifies the surface tension of the sample presentation device to direct the positioning of the liquid sample drop. For example, the surface tension of the electro-wettable sites may be variably altered during use to be in either a hydrophobic or a hydrophilic state (with reference to its state when utilized with water based liquid samples) so as to direct the liquid sample drop. One example of a mechanism for variably altering the surface tension of the electro-wettable sites during use is the application of an electrical potential applied between a liquid sample drop and the electro-wettable site. Controlling the fluid path via electrical actuation of the electro-wettable sites (electrodes) enables the analytes to be concentrated on the terminal electro-wettable site. Furthermore, with respect to the path which originates at the microwell, the surface area of each succeeding intermediary electro-wettable site may be equal to or less than that of the preceding electro-wettable site. For example, each successive electro-wettable site may have a surface area which is about half of the surface area of the preceeding electro-wettable site.

The sample presentation device may comprise an individual sample presentation site or a plurality of individual sample presentation sites, wherein each sample presentation site is further comprised of a physical or virtual microwell which can receive a liquid sample drop; one or more intermediary electro-wettable sites at least one of which is contiguous to the microwell; and a terminal electro-wettable site which confines the deposition of analytes and matrix to within a predetermined area. The plurality of individual sample presentation device may, for example, include 2 to 1536 individual sample presentation devices and be configured in a manner analogous to Life Science Industry's standard 96, 384 and 1536 multiwell plates. Such configurations permit compatibility with standardized multiwell plate processors and laboratory liquid handling robots.

The virtual microwell provides a containment which holds a liquid drop when deposited therein. The containment can result from any suitable configuration. For example, the containment may be achieved by an actuated electro-wettable zone or a patterned zone exhibiting greater wettability (lower surface tension) than the surrounding area. In the later case, the surface of the microwell is chemically-modified so as to exhibit either hydrophobic and non-adsorptive properties with respect to analytes, or hydrophobic and adsorptive properties with respect to analytes. The shape of the microwell may provide for some overlap between the edge of a liquid drop residing therein and one or more contiguous electro-wettable sites so as to facilitate the transfer of a liquid drop to adjacent electro-wettable sites.

When the surface of the microwell is both hydrophobic and adsorptive, analytes can be selectively retained from low elutropic strength buffers and washed with either acidified water or low ionic strength buffers to remove detergents and salts known to interfere with mass spectrometric detection prior to application of matrix solution.

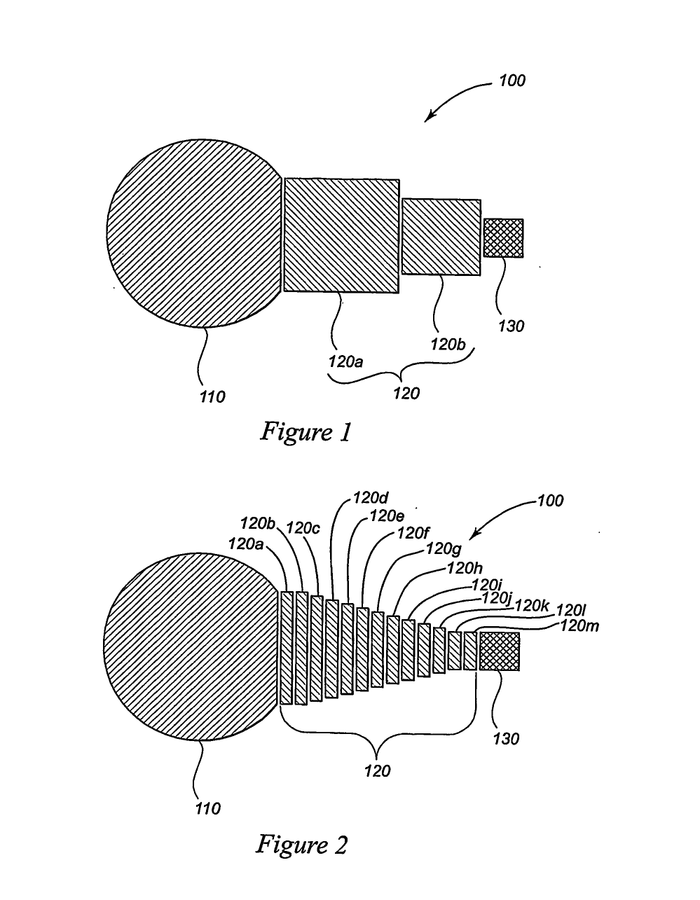

The descriptions that follow are merely exemplary and do not limit the scope of the invention. FIGS. 1-7B depict various embodiments of the sample presentation device which are identified at 100. The embodiments of the sample presentation device depicted in FIGS. 1-7B each comprise a virtual microwell as identified at 110, a series of intermediary electro-wettable sites as identified collectively at 120, and a terminal electro-wettable site which is identified at 130. Note that a single intermediary electro-wettable site 120 may also be utilized individually. Virtual microwell 110 is adapted to receive a liquid sample drop. When more than one intermediary electro-wettable site 120 is utilized, at least one is contiguous to the microwell. Note also that when more than one intermediary electro-wettable site 120 is utilized, the surface area of each succeeding intermediary electro-wettable site is equal to or less than that of the preceding electro-wettable site. Terminal electro-wettable site 130 confines the deposition of analytes and matrix to within a predetermined area.

The surface of microwell 110 is either rendered hydrophilic by actuation of an electro-wettable site having a thin film hydrophobic surface or chemically-modified so as to exhibit either hydrophobic and non-adsorptive properties with respect to analytes or hydrophobic and adsorptive properties with respect to analytes. Each of the electro-wettable sites 120 and 130 modifies the surface of sample presentation device 110 between hydrophobic and hydrophilic states in response to an electrical potential applied between a liquid sample drop and the electro-wettable site so as to direct the positioning of the liquid sample drop.

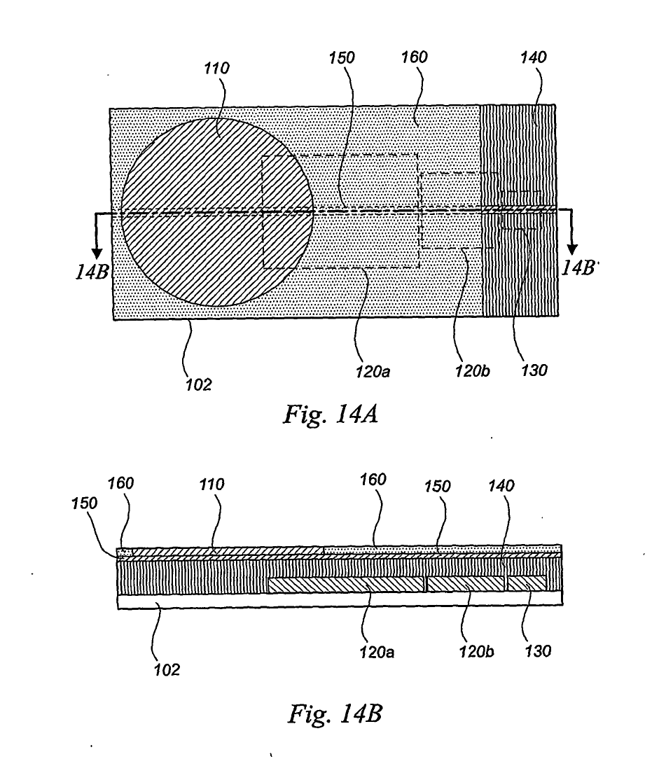

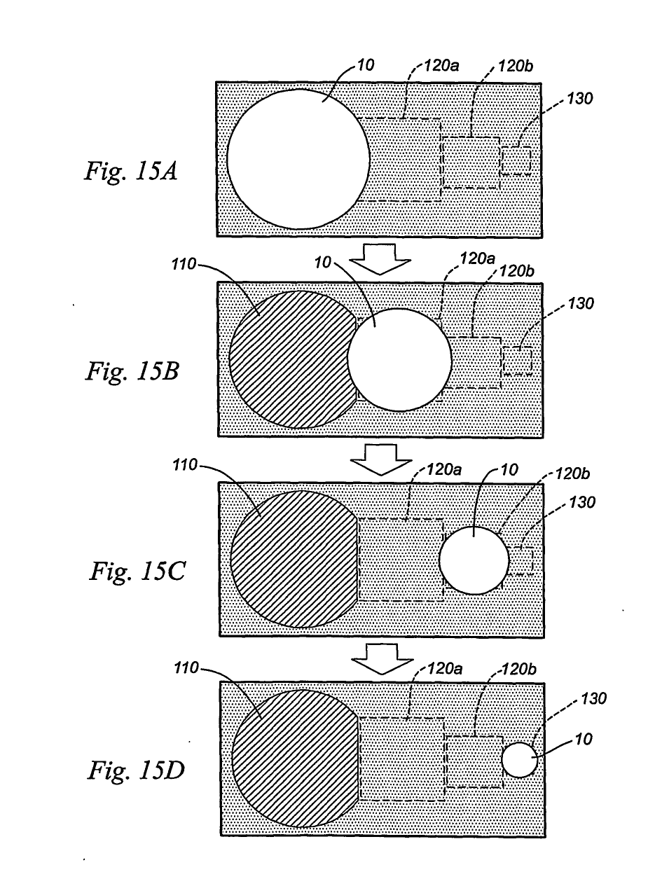

FIG. 1 depicts sample presentation device 100 with two electro-wettable sites 120a and 120b in a linear arrangement. Electro-wettable site 120a is adjacent to microwell 110. Electro-wettable site 120b is adjacent to terminal electro-wettable site 130. The steps of utilizing a sample presentation device are discussed below with reference to FIGS. 14A-14D and FIGS. 15A-15D which depict the sequential movement of liquid sample drop 10. Note that sample presentation device 100, as shown in FIG. 1, corresponds with the sample presentation device shown in FIGS. 14A-14D.

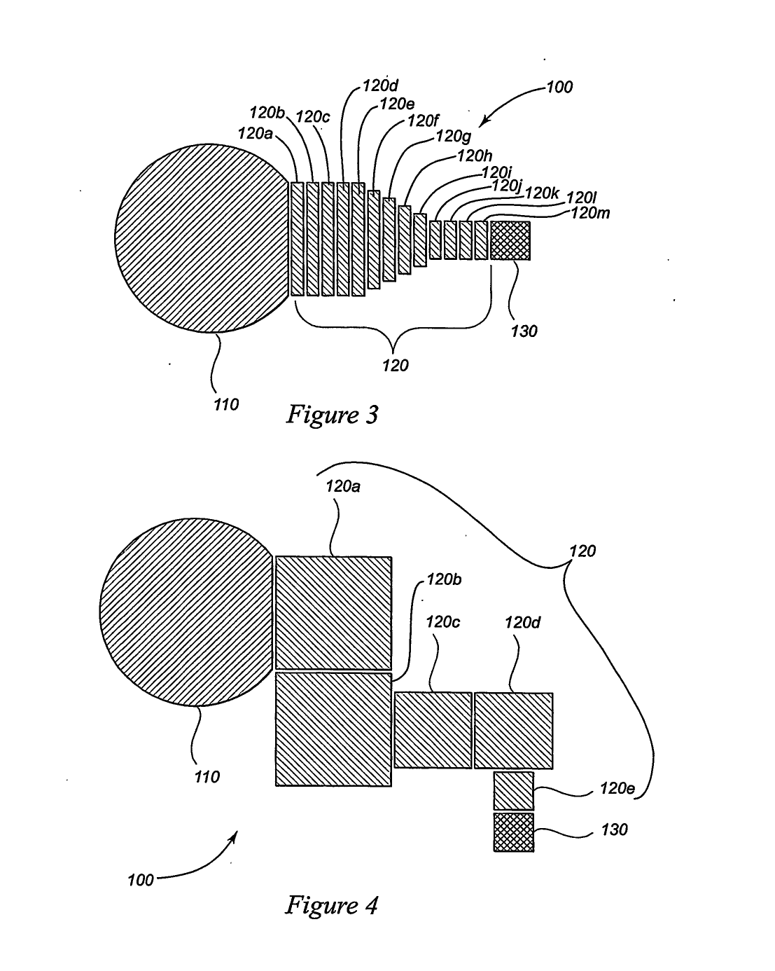

FIGS. 2 and 3 depict embodiments which are in a linear arrangement like the embodiment depicted n FIG. 1. The embodiments depicted in FIGS. 2 and 3 have more intermediary electrical-wettable sites 120 than the embodiment depicted in FIG. 1. The series of intermediary electrical-wettable sites 120a-120m shown in FIG. 2 is arranged to have sequentially smaller surface areas, with the exception of sites 120a-120b which are equal in surface area. The sequential series of sites 120a-120m shown in FIG. 3 includes a contiguous sub-series with equal surface areas upstream at sites 120a-120e and a contiguous sub-series with equal surface areas downstream at sites 120j-m. Between the equally sized series, there is a sub-series with gradually smaller surface areas as shown at 120f-120i.

Another difference between the embodiment shown in FIG. 1 and those shown in FIGS. 2 and 3 is the relative size of the last site in the series of electrical wettable sites 120 relative to terminal electro-wettable site 130. In the embodiment shown in FIG. 1, intermediary electrical wettable site 120b is larger than terminal electro-wettable site 130. In contrast, the embodiments depicted in FIGS. 2 and 3 each have a last site in the series of electrical wettable sites 120 which has a smaller surface area relative to terminal electro-wettable site 130.

FIG. 4 depicts an embodiment of the sample presentation device having a plurality of intermediary electro-wettable sites, identified at 120a-e, in a path which is not a straight line. Portions of the path comprise a straight line, however, the overall path is non-linear. Like the embodiments described with reference to FIGS. 1-3, sample presentation device 100, in addition to a series of intermediary electro-wettable sites 120, comprises a virtual microwell 110 and a terminal electro-wettable site 130.

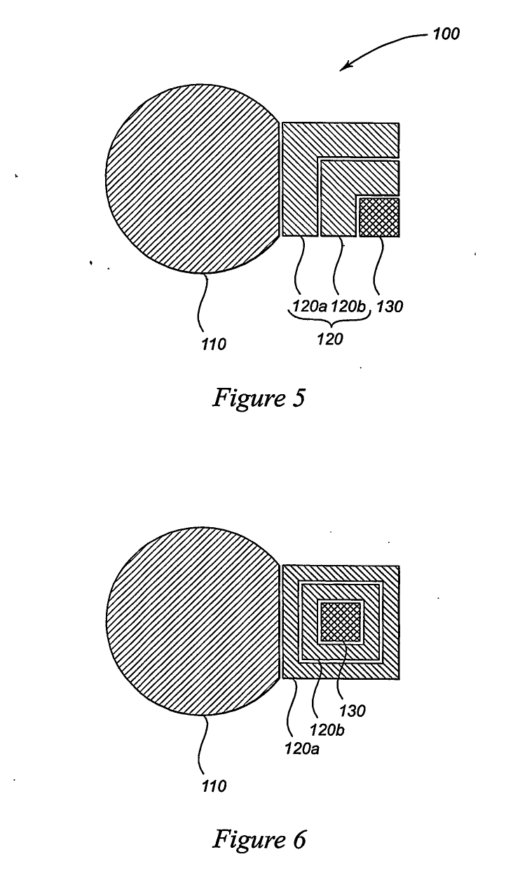

FIG. 5 provides an example of an embodiment of the sample presentation device having a plurality of intermediary electro-wettable sites, identified at 120a-b, which are nested. The configuration of intermediary electro-wettable sites 120a-b may also be described as being partially nested or nested such that an intermediary electro-wettable site only partially surrounds an adjacent smaller intermediary electro-wettable site. FIGS. 15A-15D depict the use of the sample presentation device 100 shown in FIG. 5.

FIG. 6 depicts an embodiment of a sample presentation device having a plurality of intermediary electro-wettable sites, identified at 120a-b, which are nested. In contrast to the embodiment shown in FIG. 5, the intermediary electro-wettable sites 120a-b, are nested in a configuration such that intermediary electro-wettable site 120a fully surrounds intermediary electro-wettable site 120b. The series of intermediary electro-wettable sites 120a-b concentrically directs the liquid sample drop inward toward terminal electro-wettable site 130 as the respective surface tension of each intermediary electro-wettable sites 120a-b is altered via electronic actuation of intermediary electro-wettable sites 120a-b.

FIG. 7A provides another example of an embodiment of the sample presentation device having a plurality of intermediary electro-wettable sites, identified at 120a-b, which are nested. More particularly, plurality of intermediary electro-wettable sites 120a-b are partially nested or nested such that an intermediary electro-wettable site only partially surrounds an adjacent smaller intermediary electro-wettable site. Note that all of the plurality of intermediary electro-wettable sites, identified at 120a-b and microwell 110 have a shape which is generally elliptical. Terminal electro-wettable site 130 is also slightly elliptical but is less elongated than adjacent intermediary electro-wettable site 120.

With reference to FIG. 7B, an photographic image of a sample presentation described above with reference to FIG. 7A is provided. Also shown in FIG. 7B is a thin hydrophobic film 150.

### Fabrication of Electrowetting Sample Presentation Devices

Manufacture of the sample presentation device can be realized through microfabrication technologies familiar to those skilled in the art. The electro-wettable sites may comprise a substantially planar laminate having, respectively, a non-conducting substrate, an addressable electrode, a dielectric thin film and a hydrophobic thin film surface for contacting the liquid sample drop. Based on present photolithography technology, the intermediary electro-wettable sites may conveniently comprise 4-5 segments.

The non-conducting substrate may be selected from, but not limited to, one of silicon, glass, aluminum, steel and quartz. The addressable electrode may be selected from, but not limited to, one of chromium, copper, gold, indium tin oxide (ITO), platinum and silver. The dielectric thin film may be selected from, but not limited to, one of aluminum oxide, barium strontium titanate (BST), noron nitride, Parylene C, Parylene N, polyimide, silicon dioxide, silicon nitride, spin-on glass (SOG) and titanium dioxide. Finally, the hydrophobic thin film surface may be selected from, but not limited to, one of polyethylene terephthalate (PET) ethylene trifluoroethylene (ETFE), polyvinylidene difluoride (PVDF), polyvinylfluoride (PVF), ethylenechloro trifluoroethylene (ECTFE), polytetrafluoro ethylene (PTFE), polyurethane (PFA), Teflon AG and cyclized perfluoro polymer (CYTOP).

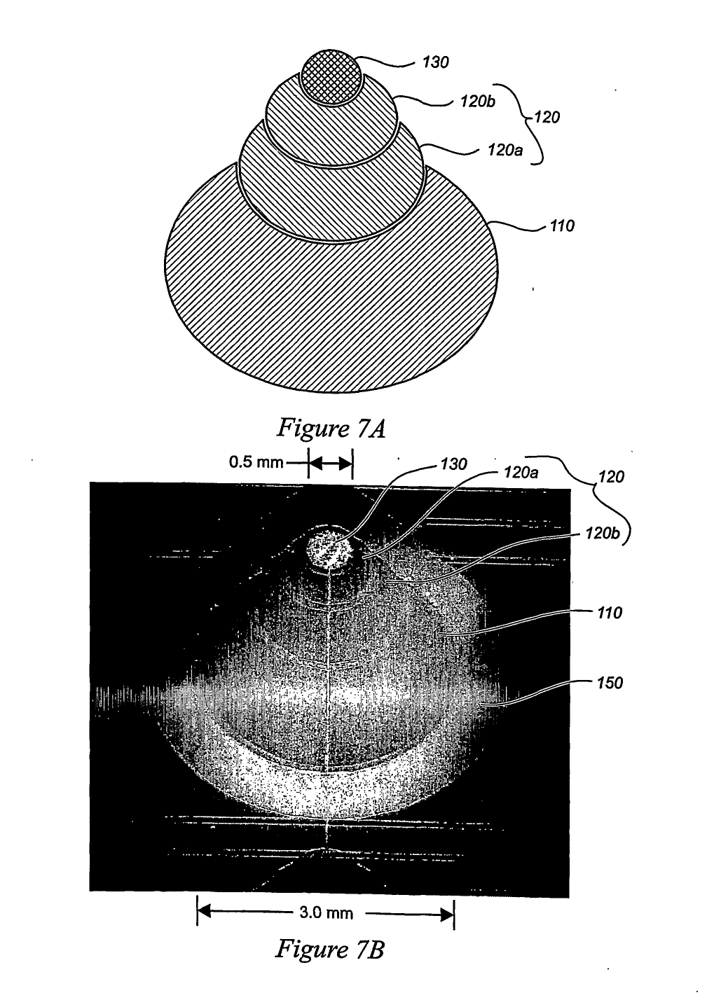

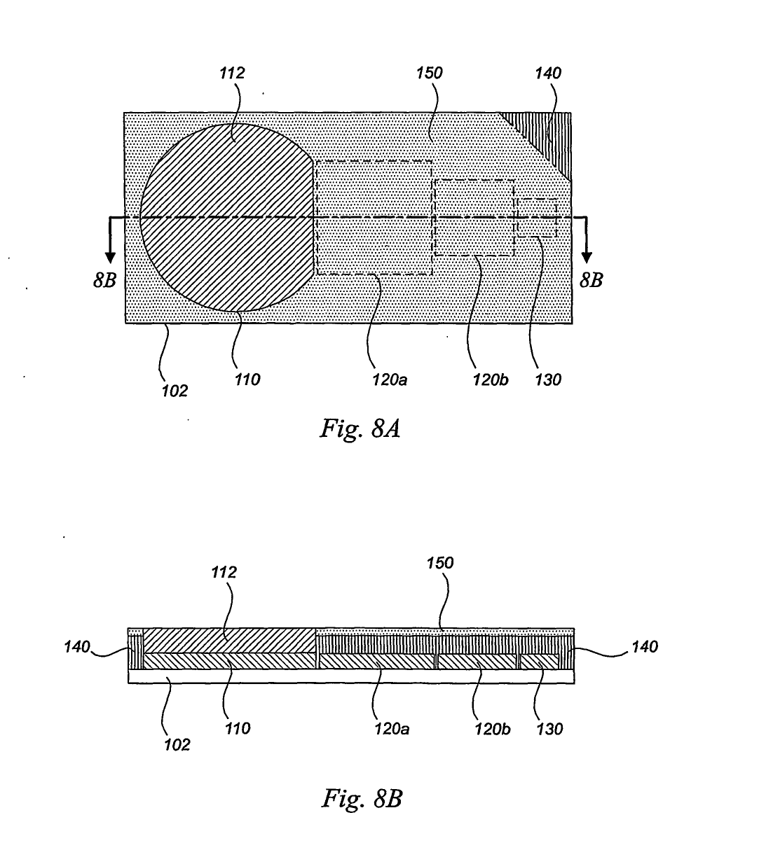

The descriptions that follow are merely exemplary and do not limit the scope of the invention. With reference to FIGS. 8A and 8B, sample presentation device 100 is depicted as comprising a non-conducting substrate 102, a physical or virtual microwell 110 having a chemically-modified surface 112 which exhibits either hydrophobic and non-adsorptive properties with respect to analytes or hydrophobic and adsorptive properties with respect to analytes, two or more intermediary electrodes 120a and 120b, and a terminal electrode 130. The electrodes 120a, 120b and 130, as well as the surrounding area (with the exception of the area of microwell 110) are covered with a dielectric film 140, which is further covered with a thin hydrophobic film 150.

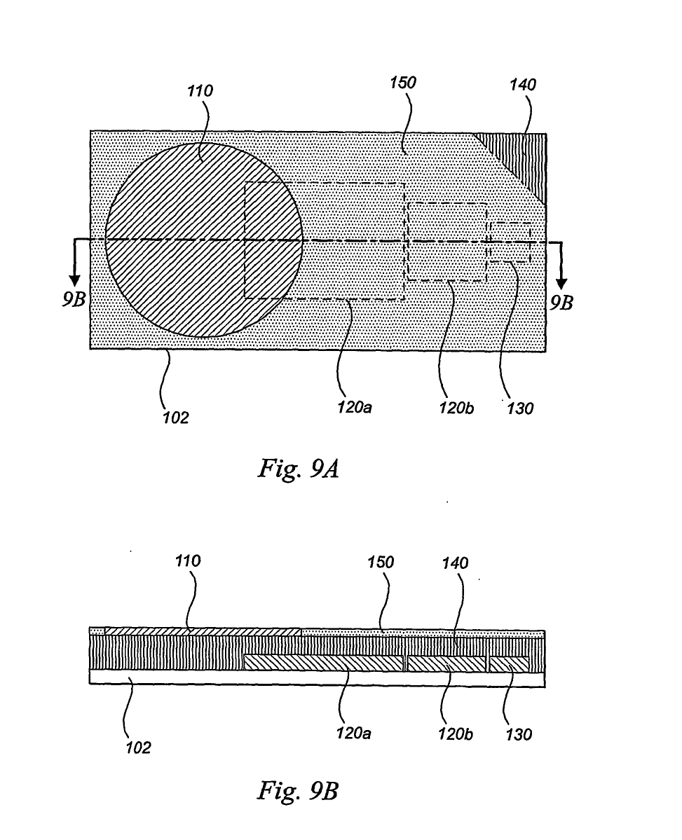

With reference to FIGS. 9A and 9B, sample presentation device 100 is depicted as comprising a non-conducting substrate 102, two or more intermediary electrodes 120a and 120b, and a terminal electrode 130. The electrodes 120a, 120b and 130, as well as the surrounding area are covered with a dielectric film 140, which is further covered with a thin hydrophobic film 150 expect in the area corresponding to the microwell 110. The surface of the virtual microwell 110 is chemically-modified so as to exhibit either hydrophobic and non-adsorptive properties with respect to analytes or hydrophobic and adsorptive properties with respect to analytes. The area of the first intermediary electro-wettable site 120a overlaps the area of the virtual microwell 110 to enable the efficient transfer of the liquid sample drop from virtual microwell 110 to the first intermediary electro-wettable site 120a.

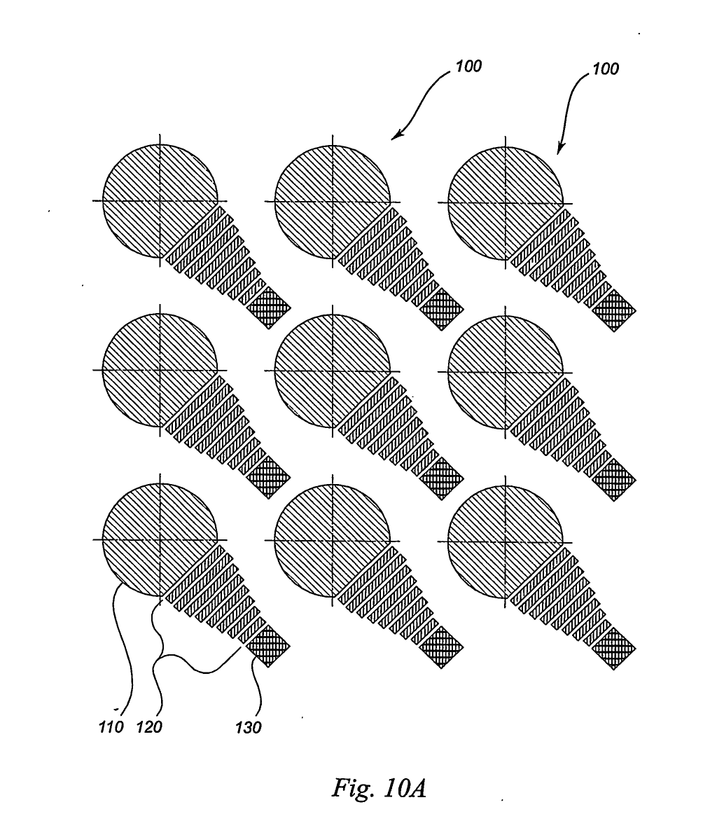

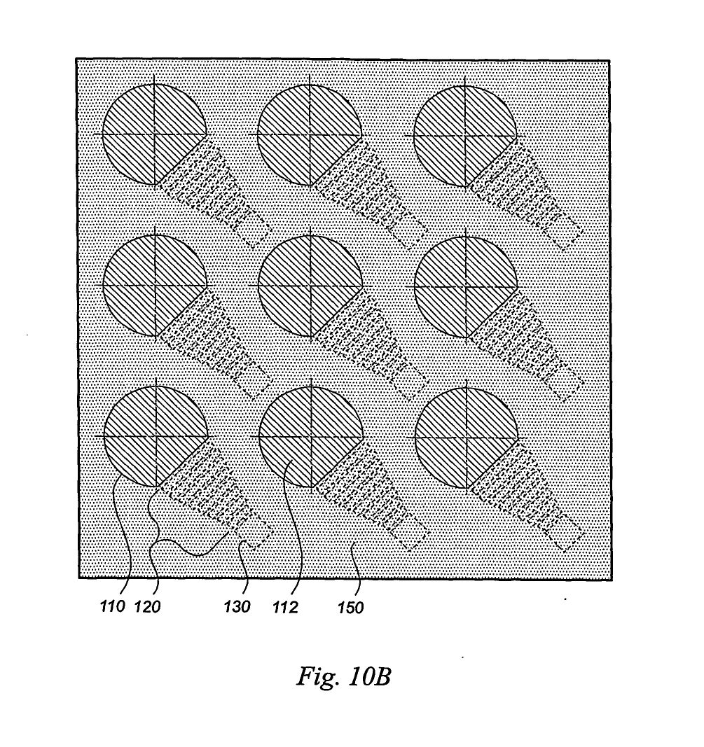

With reference to FIG. 10A, a plurality of sample presentation devices 100 may also be utilized wherein each sample presentation device 100 comprises a virtual microwell 110 which can receive liquid sample drops, each of which has associated with it two or more intermediary electro-wettable sites 120, at least one of which is contiguous to microwell 110, and a terminal electro-wettable site 130 which confines the deposition of analytes and matrix to within a predetermined area. The surface of the microwells 110 is chemically-modified so as to exhibit either hydrophobic and non-adsorptive properties with respect to analytes or hydrophobic and adsorptive properties with respect to analytes. Each of the electro-wettable sites 120 and 130 modifies the surface of the sample presentation device between hydrophobic and hydrophilic states in response to an electrical potential applied between a liquid sample drop and the electro-wettable sites so as to direct the positioning of the liquid sample drops. The surface area of each succeeding intermediary electro-wettable site is equal to or less than that of the preceding electro-wettable site. FIG. 10B shows the same plurality of sample presentation devices 100 shown in FIG. 10A with each of the electrodes 120 and 130 covered with a dielectric film which is, in turn, covered with a thin hydrophobic film 150.

With reference to FIG. 11, the plurality of sample presentation devices 100 is shown configured in a manner analogous to Life Science Industry's standard 96 multiwell plates so as to be compatible with standardized multiwell plate processors and laboratory liquid handling robots. While any plurality may be utilized, the plurality may be configured to be analogous to the Life Science Industry's standard 384 and 1536 multiwell plates. The plurality of sample presentation devices 100 depicted in FIG. 11 are shown configured like those depicted in FIG. 10B. having from 2 to 1536 individual sample presentation sites, wherein each sample presentation site is further comprised of a physical or virtual microwell which can receive a liquid sample drop; one or more intermediary electro-wettable sites at least one of which is contiguous to the microwell; and a terminal electro-wettable site which confines the deposition of analytes and matrix to within a predetermined area. The sample presentation device having a plurality of individual sample presentation sites may be configured in a manner analogous to Life Science Industry's standard 96, 384 and 1536 multiwell plates, so as to be compatible with standardized multiwell plate processors and laboratory liquid handling robots.

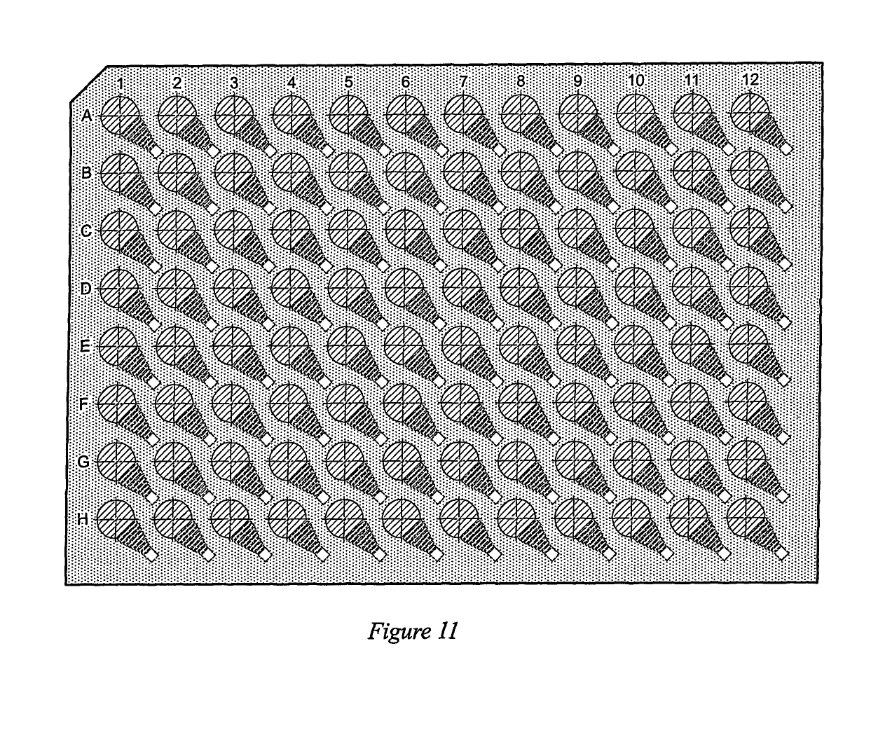

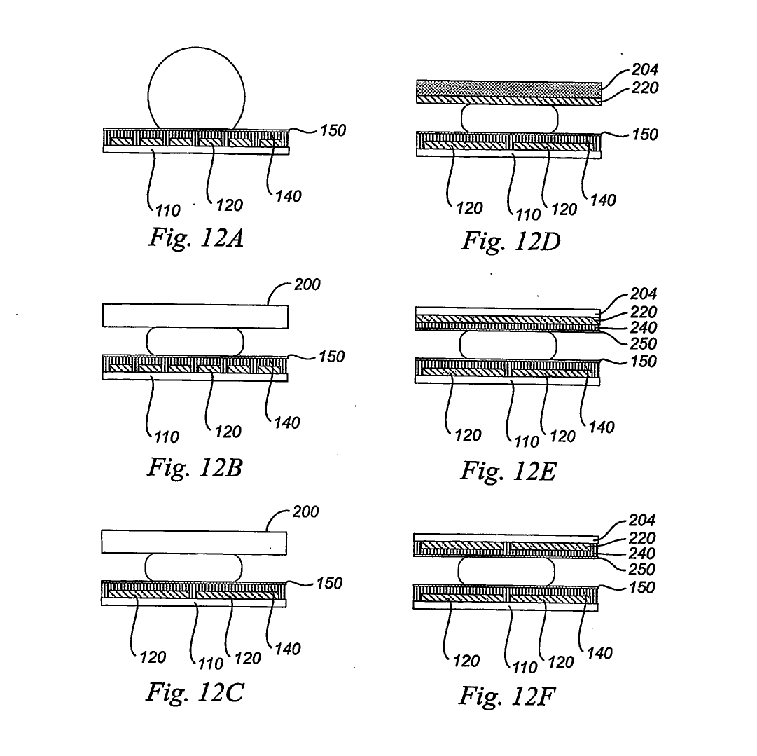

With reference to FIGS. 12A-12F, a variety of electrode arrangements may be exploited for fabrication of the sample preparation device of the present invention. These arrangements include, but are not limited to, narrow electro-wetting electrodes (with respect to the diameter of the liquid drop) utilized without an upper cover plate (FIG. 12A), narrow electro-wetting electrodes 120 utilized in conjunction with an upper cover plate (FIG. 12B) as identified at 200, and wide electro-wetting electrodes 120 (with respect to the diameter of the liquid drop) utilized in conjunction with an upper cover plate (FIG. 12C). These arrangements also include the use of an upper cover plate having more complex configurations. For example, FIG. 12D shows wide electro-wetting electrodes 120 utilized in conjunction with upper plate 200 having an upper grounding electrode 220 (FIG. 12D) and a non-conducting layer 204. FIGS. 12E and 12F show wide electro-wetting electrodes 120 utilized in conjunction with an upper grounding electrode 220 having a hydrophobic thin coating 250 to minimize nonspecific adsorption of analytes. In FIGS. 12E and 12F, electrodes 220 are between substrate 202 and a dielectric film 240. FIG. 12F has wide electro-wetting electrodes 120 utilized in conjunction with an upper plate 200 having a mirror-image set of electro-wetting electrodes 220. Alternatively, the electrowetting electrodes as well as the grounding electrode(s) may be fabricated into the same laminate device as described below.

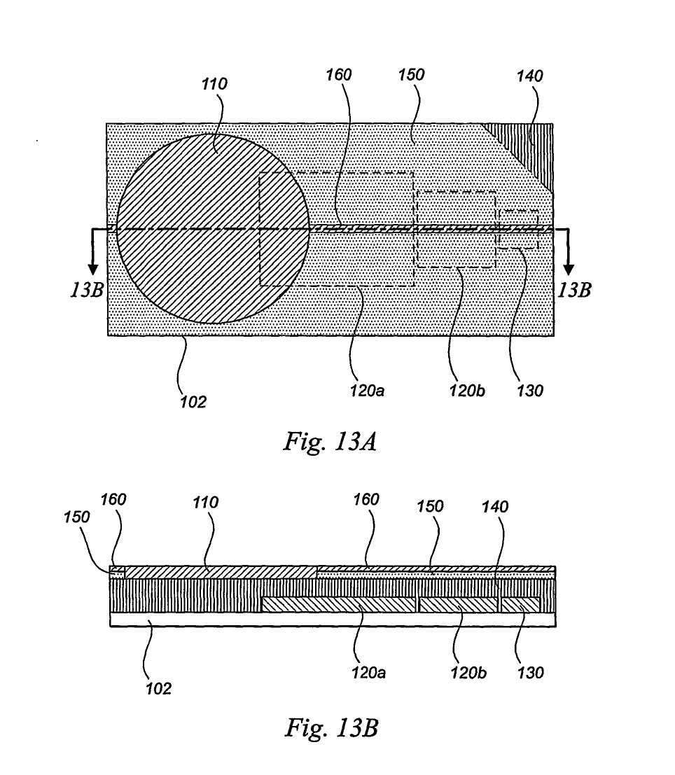

With reference to FIGS. 13A and 13B, the sample presentation device is shown comprising a non-conducting substrate 102, two intermediary electro-wettable sites 120a and 120b, and a terminal electrode 130. The electrodes 120a, 120b and 130, as well as the surrounding area are covered with a dielectric film 140, which is further covered with a thin hydrophobic film 150 expect in the area corresponding to the microwell 110. The thin metallic grounding electrode 160 is patterned on the surface of the hydrophobic film 150. Further, the surface of the virtual microwell 110 is chemically-modified so as to exhibit either hydrophobic and non-adsorptive properties with respect to analytes or hydrophobic and adsorptive properties with respect to analytes. The area of the first intermediary electro-wettable sites 120a overlaps the area of the virtual microwell 110 to enable the efficient transfer of the liquid sample drop from the virtual microwell 110 to the first intermediary electro-wettable sites 120a (also referred to as the first intermediary electrode). The configuration illustrated in FIGS. 13A and 13B eliminates the need for either an upper cover plate or upper grounding electrode as illustrated in FIGS. 12B through 12F.

With reference to FIGS. 14A and 14B, the sample presentation device is shown comprising a non-conducting substrate 110, two or more intermediary electrodes 120a and 120b, and a terminal electrode 130. The electrodes 120a, 120b and 130, as well as the surrounding area are covered with a dielectric film 140. The thin metallic grounding electrode 150 is patterned on the surface of the dielectric film 140, which is further covered with a thin hydrophobic film 150 expect in the area corresponding to the microwell (7). Further, the surface of the virtual microwell 110 is chemically-modified so as to exhibit either hydrophobic and non-adsorptive properties with respect to analytes or hydrophobic and adsorptive properties with respect to analytes. The area of the first intermediary electrode 120a overlaps the area of the virtual microwell to enable the efficient transfer of the liquid sample drop from the virtual microwell to the first intermediary electrode. The configuration illustrated in FIGS. 14A and 14B eliminates the need for either an upper cover plate or upper grounding electrode as illustrated in FIGS. 12B through 12F. Furthermore, the thin metallic grounding electrode 5 may be patterned simultaneously with the virtual microwell 110, thereby simplifying the fabrication process.

### Operation of Electrowetting Sample Presentation Devices

Once deposited into the microwell, a liquid sample drop containing dissolved analytes and matrix is allowed to evaporate until the volume of the drop is significantly reduced, and then transferred onto one or more adjacent electro-wettable sites by actuation of the appropriate electrodes. As the liquid drop continues to evaporate, it is repeatedly transferred along a path in which the surface area of each succeeding electro-wettable site is equal to or less than that of the preceding electro-wettable site. Lastly, the liquid sample drop (the volume of which has been significantly reduced owing to evaporation either by ambient conditions or by heating) arrives at the terminal electro-wettable site. As the liquid drop finally dries, analytes are deposited as a homogeneous thin film on the surface of the terminal electro-wettable site. As a result, the sample presentation device of the present invention enables the confined deposition of analytes with a concomitant increase in sensitivity of mass spectrometric detection. Furthermore, unlike prior art sample supports the confined deposition of analytes is to a great extent independent of the initial volume of the liquid sample drop residing within the microwell.

A liquid drop initially retained within the virtual microwell of the sample presentation device wets the surface of one or more adjacent electro-wettable sites in response to an applied electrical potential. When the potential is applied, the contact angle associated with that portion of the liquid drop in contact with the electro-wettable site is instantaneously reduced due to the local change in surface tension which results from the trapping of ions at the interface between the liquid drop and the surface of the electro-wettable site. Electrowetting results from an increase in surface energy in the actuated electro-wettable site as compared to that of the physical or virtual microwell, thereby facilitating the movement of the liquid drop from the microwell to one or more adjacent electro-wettable sites. Similarly, a liquid drop residing on one or more initially-actuated electro-wettable sites wets the surface of one or more adjacent electro-wettable sites in response to an applied electrical potential. If the electrical potential associated with the initially-actuated electro-wettable sites is discontinued while that associated with the newly-actuated electro-wettable sites is continued, movement of the liquid drop from one set of electro-wettable sites to an adjacent set of electro-wettable sites is facilitated.

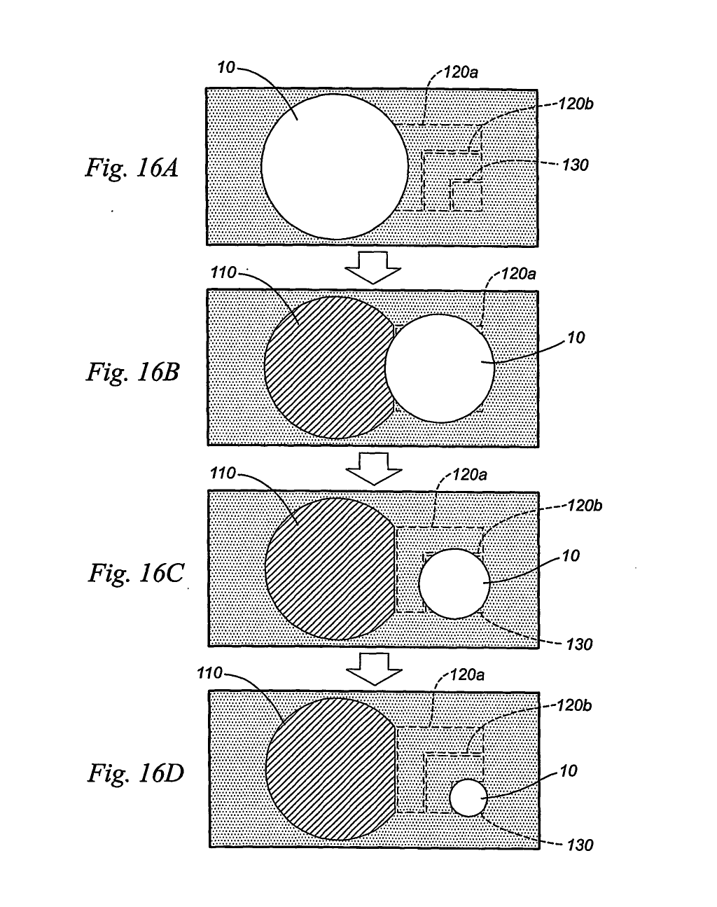

The descriptions that follow are merely exemplary and do not limit the scope of the invention. FIGS. 15 and 16 illustrate the operation of the sample preparation device of the present invention. The liquid sample drop initially resides in the physical or virtual microwell of the present invention (FIGS. 15A and 16A). The drop is allowed to dry with a concomitant reduction in volume and then transferred to the electro-wettable site which is contiguous with the microwell (FIGS. 15B and 16B). The drop is allowed to further dry with a further concomitant reduction in volume and then transferred to the adjacent electro-wettable site which is contiguous with the terminal electro-wettable site (FIGS. 15C and 16C). Finally, the drop is allowed to yet further dry and then transferred to the terminal electro-wettable site where the analytes and matrix are deposit as a thin film on the surface (FIGS. 15D and 16D).

### Use of Electrowetting Sample Presentation Devices

A significant increase in the sensitivity of detection results from the process described in FIGS. 15 and 16. In the absence of the electro-wettable sites, the average analyte surface concentration per unit area in the physical or virtual microwell is equal to the total analyte concentration divided by the surface area (assuming the deposed thin film of analyte has negligible thickness). In the presence of the electro-wettable sites, however, the deposition of analyte is confined to the terminal electro-wettable site wherein the average analyte surface concentration per unit area is equal to the total analyte concentration divided by the surface area of the terminal electro-wettable site (again assuming the deposed thin film of analyte has negligible thickness). Therefore, the presence of the electro-wettable sites and in particular the terminal electro-wettable site, affords an increase in average surface concentration of analyte which is equal to the ratio of the surface area of the physical or virtual microwell to the surface area of the terminal electro-wettable site. Since the surface area of the terminal electro-wettable site is always significantly smaller than the surface area of the physical or virtual microwell, confining analyte deposition to the surface area of the terminal electro-wettable site results in a significant increase in the average surface concentration of analyte presented to the mass spectrometer with a concomitant increase in sensitivity of detection.

For example, the sample presentation device of the present invention with a microwell having a 3.0 mm diameter (about 7.069 mm² surface area) and a terminal electro-wettable site having a 0.25 mm² surface area, confines the deposition of analytes to a detection zone surface area of about 28-fold smaller than the surface area of the microwell, with an approximate 28-fold concomitant increase in average surface analyte concentration. Consequently, in principal the sample drop drying process described hereinabove would potentially afford an about 28-fold increase in sensitivity.

### Analytes

The sample presentation device of the present invention may be exploited to facilitate high sensitivity mass spectrometric detection of biological analytes selected from, but not limited to: biological macromolecules such as peptides, proteins, enzymes, enzymes substrates, enzyme substrate analogs, enzyme inhibitors, polynucleotides, oligonucleotides, nucleic acids, carbohydrates, oligosaccharides, polysaccharides, avidin, streptavidin, lectins, pepstatin, protease inhibitors, protein A, agglutinin, heparin, protein G, concanavalin; fragments of biological macromolecules set forth above, such as nucleic acid fragments, peptide fragments, and protein fragments; complexes of biological macromolecules set forth above, such as nucleic acid complexes, protein-DNA complexes, gene transcription complex, gene translation complex, membrane, liposomes, membrane receptors, receptor ligand complexes, signaling pathway complexes, enzyme-substrate, enzyme inhibitors, peptide complexes, protein complexes, carbohydrate complexes, and polysaccharide complexes; small biological molecules such as amino acids, nucleotides, nucleosides, sugars, steroids, lipids, metal ions, drugs, hormones, amides, amines, carboxylic acids, vitamins and coenzymes, alcohols, aldehydes, ketones, fatty acids, porphyrins, carotenoids, plant growth regulators, phosphate esters and nucleoside diphosphosugars, synthetic small molecules such as pharmaceutically or therapeutically effective agents, monomers, peptide analogs, steroid analogs, inhibitors, mutagens, carcinogens, antimitotic drugs, antibiotics, ionophores, antimetabolites, amino acid analogs, antibacterial agents, transport inhibitors, surface-active agents (surfactants), amine-containing combinatorial libraries, dyes, toxins, biotin, biotinylated compounds, DNA, RNA, lysine, acetylglucosamine, procion red, glutathione, adenosine monophosphate, mitochondrial and chloroplast function inhibitors, electron donors, carriers and acceptors, synthetic substrates and analogs for proteases, substrates and analogs for phosphatases, substrates and analogs for esterases and lipases and protein modification reagents; and synthetic polymers, oligomers, and copolymers such as polyalkylenes, polyamides, poly(meth)acrylates, polysulfones, polystyrenes, polyethers, polyvinyl ethers, polyvinyl esters, polycarbonates, polyvinyl halides, polysiloxanes, and copolymers of any two or more of the above. Moreover, analytes that may be handled by the sample presentation devices of the present inventions may be non-biological.

Analytes may be dissolved in aqueous buffers, organic solvents or mixtures thereof. Buffers may be selected from those prepared from volatile constituents including, but not limited to: ammonium acetate, ammonium bicarbonate, ammonium carbonate, ammonium citrate, triethylammonium acetate and triethylammonium carbonate, triethyl-ammonium formate, trimethylammonium acetate, trimethylammonium carbonate and trimethylammonium formate. Aqueous samples containing high concentrations of non-volatile detergents (>0.1%) should be desalted prior to analysis as the presence of detergent may counteract and analyte-confining properties of the detection zone. Organic solvents may be selected from those know to be miscible in aqueous buffers and to promote the solubility of biological analytes including, but not limited to: acetic acid, acetone, acetonitrile, ethanol, N,N-dimethylformamide (DMF), N,N-dimethylsulfoxide (DMSO), formic acid, heptafluorobutyric acid, methanol, N-methylpyrolidone (NMP), 2,2,2-trifluoroethanol and trifluoroacetic acid.

Laser desorption/ionization time-of-flight mass spectrometry requires an energy absorbing molecule be applied to the surface of the sample presentation device to absorb energy and thereby effect the ionization of analytes. Energy absorbing molecules utilized in Matrix-Assisted Laser Desorption Ionization (MALDI) and Surface Enhanced Laser Desorption Ionization (SELDI) are frequently referred to as “matrix.” Reagents frequently utilized for detection of biological analytes include trans-3,5-dimethoxy-4-hydroxycinnamic acid (sinapinic acid, SA), α-cyano-4-hydroxycinnamic acid (ACHA) and 2,5-dihydroxybenzoic acid (DHBA). Owing to the limited solubility of the aforementioned matrix reagents in water, stock solutions of these reagents often contain 50% to 100% organic solvent.

When utilized in conjunction with the sample presentation device of the present invention, stock solutions containing matrix reagents are added to aqueous samples prior to applying the sample to the surface of the sample presentation device. Alternatively, stock solutions containing matrix reagents may be applied to the surface of the sample presentation device after sample application and drying. In this instance, stock solutions containing a high percentage of organic solvent may be utilized to maximize dissolution of the analytes deposed on the surface of the microwell into the stock solution.

### Applications of Electrowetting Sample Presentation Devices

Applications of the sample presentation devices are described below. The descriptions that follow are merely exemplary and do not limit the scope of the invention. The sample presentation device of the present invention facilitates the mass spectrometric analysis of biological analytes recovered from fractionation schemes that exploit either column liquid chromatography or electrophoresis. In particular, utility results from the combination of the liquid-holding capacity of the device (which enables direct collection of chromatographic fractions, samples purified by electrophoresis, and samples recovered from biosensors without prior sample volume reduction) and the precise positioning of the sample and increased sensitivity of detection (which enables automated data acquisition). Furthermore, the availability of the sample presentation device in standard 96-well, 384-well and 1536-well formats enables sample collection and processing on multi-well plate processing devices and laboratory liquid handling robots. Consequently, the sample presentation device of the present invention may be exploited to enable high-throughput mass spectrometric platforms as are needed to support the emergence of proteomics and are currently unavailable.

The liquid-holding capacity afforded by the sample presentation device of the present invention enables direct collection of fractions recovered from affinity chromatography, hydrophobic interaction chromatography, ion exchange chromatography, immobilized metal ion affinity chromatography and size exclusion chromatography, as well as fractions recovered from orthogonal separations involving sequential utilization of two or more of the chromatographic approaches enumerated above. The volumes associated with fractions recovered from chromatographic separations involving biological analytes are usually in the range of from about 5 μL to greater than about 100 μL (unless recovered from nano-scale separations). Volumes greater than about 3 μL are known to be incompatible with prior art mass spectrometer sample supports unless applied as small aliquots (e.g., 0.5 μL) which must be allowed to dry prior to each application. Manual application of sample aliquots is both labor intensive and time consuming. Alternatively, protocols undertaken to reduce sample volume prior to sample application on prior art mass spectrometer sample presentation devices are labor intensive, time consuming, and often afford poor recoveries due to the loss of sample associated with the handling of small volumes.

Contemporary protein quantification often involves enzymatic digestion of proteins purified either by column liquid chromatography or excised from 2-dimensional electrophoreses gels. Protein digests require desalting on reverse phase liquid chromatography (RPLC) columns prior to mass spectrometry. Unfortunately, automated desalting by high performance RPLC on both narrow-bore and micro-bore columns (2.1 and 1.0 mm ID, respectively) routinely affords sample volumes that are incompatible with prior art mass spectrometer devices used to store samples. The sample presentation devices of the current invention, on the other hand, are suitable for direct collection and subsequent analysis of protein digests desalted by high performance RPLC on both narrow-bore and micro-bore columns.

The liquid-holding limitations known to be associated with prior art mass spectrometer sample presentation devices have prompted the development of various micro-column liquid chromatography approaches involving the use of small pipette tips packed with minute quantities of chromatographic media (e.g., ZipTips®). Micro-column approaches enable the desalting of protein digests with a concomitant reduction in sample volume reported to be sufficient to enable the sample to be applied directly to prior art mass spectrometer devices for retaining samples. However, the manual step-wise application of two or three aliquots is a far more common practice. The sample presentation devices of the present invention, on the other hand, are suitable for direct collection and subsequent analysis of protein digests desalted by micro-column RPLC.

Surface plasmon resonance (SPR) biosensors exploit immobilized proteins to study protein-protein and other biological interactions. In principal, commercial biosensors and mass spectrometry are highly compatible in that the quantity of protein captured by interaction with an immobilized protein on a biosensor surface is a suitable quantity for mass spectrometric analysis. Although direct detection of analytes on the biosensor surface has been demonstrated, the elution of retained analytes from the biosensor system appears a much more attractive approach due to the fact that the biosensor surface is expensive and may be recycled many times. Unfortunately, a large volume of eluant is required to recover an analyte from a biosensor and the concentration of analyte in the eluant is far too low for optimum mass spectrometry. The sample presentation device of the present invention is suitable for direct collection of analytes recovered from biosensor systems and affords the increased sensitivity of detection required for routine mass spectrometric analysis. Additionally, the sample presentation device may be configured to a standard 96-well format so as to be compatible with sample collection devices already integrated into biosensor systems and can be exploited to enable automated sample collection for mass spectrometric analysis.

### Example 1

The details of the stepwise fabrication of an electrowetting-on-dielectric apparatus of the present invention follow:

The surface of a 4″ silicon wafer was exposed to wet O₂/N₂ at 1045° C. for 45 min to prepare a Thermal Oxide (2500 Å) insulator film.

The first metal conductive layer (control electrode elements and interconnects), comprised of 60 Å of Ti/W, 300 Å of Au and 60 Å of Ti/W was sputtered onto the Thermal Oxide surface.

Photoresist was spin-coated and patterned by contact printing to define the electrode pattern. The metal conductive layer was wet etched at room temperature employing the following sequence: (1) 30% H₂O₂ in TFA for 90 sec; (2) 30% H₂O₂ for 30 sec; and (3) 30% H₂O₂ in TFA for 90 sec.

Photoresist was stripped using reagent EKC830 for 10 min followed by reagent AZ300 for 5 min. The wafers were rinsed in deionized water and dried in a vacuum spinner.

Unstressed silicon nitride (dielectric, 1000 Å) was deposited by PECVD (Plasma Enhanced Chemical Vapor Deposition) at 350° C.

Photoresist was spin-coated and patterned by contact printing to expose contacts (connectors) and vias. The silicon nitride was dry etched through the photoresist mask by reactive ion etching (RIE) with sulfur hexafluoride gas.

The second metal conductive layer (ground electrode lines), comprised of 300 Å of Au and 60 Å of Ti/W was sputtered onto the silicon nitride surface. To provide adequate gold depth at the contacts an additional 1000 Å of Au was deposited on the contacts by shadow masking.

Photoresist was spin-coated and patterned by contact printing to define the upper ground electrode, affinity capture site and contact pattern. The metal conductive film was wet etched at room temperature with 30% H₂O₂ in TFA for 90 sec and 30% H₂O₂ for 30 sec.

Silicon dioxide dielectric (250 Å) was deposited by PECVD at 350° C.

The wafer was protected with photoresist and diced into chips.

Photoresist was stripped using reagent EKC830 for 10 min followed by reagent AZ300 for 5 min. The wafers were rinsed in deionized water and dried in a vacuum spinner.

Finally, a solution of CYTOP Amorphous Fluorocarbon Polymer (1.1% in CYTOP proprietary solvent) was spin-coated at 2500 rpm and dried at 120° C. for 10 min; 150° C. for 10 min; and 180° C. for 10 min.

### Example 2

An electrowetting-on-dielectric sample presentation device of the present invention was fabricated as described in the example immediately above. One sample presentation element of the device is pictured in FIG. 7B. When a 10 μL droplet containing 2,4-dihydroxybenzoic acid matrix (10%, w/v) in water was applied to the surface of the device with all electro-wettable zones actuated (hydrophilic), the droplet initially filled the lower three electro-wettable zones. As the droplet was allowed to evaporate over the course of 30 minutes, the lower electro-wettable zones were sequentially deactivated from bottom to top thereby confining the droplet to the upper-most electro-wettable zone. Finally, when the droplet dried, the field of matrix crystals shown in FIG. 7B was obtained.

All publications, including but not limited to patents and patent applications, cited in this specification are herein incorporated by reference as if each individual publication were specifically and individually indicated to be incorporated by reference herein as though fully set forth.

The above description fully discloses the invention including preferred embodiments thereof. Without further elaboration, it is believed that one skilled in the art can use the preceding description to utilize the invention to its fullest extent. Therefore the Examples herein are to be construed as merely illustrative and not a limitation of the scope of the present invention in any way.

It will be apparent to those having skill in the art that changes may be made to the details of the above-described embodiments without departing from the underlying principles of the invention. Embodiments of the invention in which an exclusive property or privilege is claimed are defined as follows.

1. A method for presenting liquid samples for mass spectrometry comprising:
obtaining a sample presentation device configured to enable fluid communication from a microwell to at least one intermediate electro-wettable site and then to a terminal electro-wettable site,
delivering a volume of a liquid sample containing analytes to the microwell, and
directing the liquid sample from the microwell to the terminal electro-wettable site via the intermediate electro-wettable site by altering the wettability of the intermediate electro-wettable site and the terminal electro-wettable site in order to deposit the analytes on the terminal electro-wettable site.

2. The method of claim 1, wherein the wettability of each electro-wettable site is altered by selective electrical actuation of each electro-wettable site.

3. The method of claim 1, wherein the volume of the liquid sample is reduced as it is directed from the microwell to the terminal electro-wettable site.

4. The method of claim 1, wherein the volume of the liquid sample is sequentially reduced at each electro-wettable site by evaporation as the liquid sample is directed from the microwell to the terminal electro-wettable site.

5. The method of claim 1, wherein the volume of the liquid sample is sequentially reduced at each electro-wettable site by evaporation under ambient conditions as the liquid sample is directed from the microwell to the terminal electro-wettable site.

6. The method of claim 1, wherein the volume of the liquid sample is sequentially reduced via evaporation at each electro-wettable site by heating the liquid sample as the liquid sample is directed from the microwell to the terminal electro-wettable site.

7. The method of claim 1, wherein the terminal electro-wettable site is adapted to confine the deposition of analytes to within a predetermined area.

8. The method of claim 1, wherein the sample presentation device comprises a plurality of a sample presentation sites and wherein the liquid sample is delivered to each sample presentation site via liquid handling robots.

9. A device for presenting liquid samples for mass spectrometry comprising:
a microwell adapted to receive a volume of a liquid sample containing analytes,
at least one intermediate electro-wettable site contiguous with a portion of the microwell,
a terminal electro-wettable site, and
wherein the intermediate electro-wettable site is positioned between the microwell and the terminal electro-wettable site, and
wherein the surface tension of the at least one intermediate electro-wettable site and surface tension of the terminal electro-wettable site are variably alterable to direct the movement of the liquid sample from the microwell to the terminal electro-wettable site via the at least one intermediate electro-wettable site for deposition of the analytes on the terminal electro-wettable site.

10. The device of claim 10, wherein the intermediary electro-wettable site has surface area which is greater than the surface area of the terminal electro-wettable site.

11. The device of claim 10, wherein a fluid path is defined by the microwell, the intermediary electro-wettable site and the terminal electro-wettable site, and wherein each successive site has a surface area which is equal to or less than that of the preceding electro-wettable site.

12. The device of claim 10, wherein each intermediary electro-wettable site between the microwell and the terminal electro-wettable site has surface area which is about half of the surface area of an adjacent intermediary terminal electro-wettable site and wherein the terminal electro-wettable site has surface area which is about half of the surface area of an adjacent intermediary terminal electro-wettable site.

13. The device of claim 10, wherein the microwell is adapted to contain the liquid sample.

14. The device of claim 10, wherein the microwell is adapted to contain the liquid sample by actuation of an electro-wettable zone.

15. The device of claim 10, wherein the microwell is adapted to contain the liquid sample via by a patterned zone exhibiting lower surface tension than a surrounding area.

16. The device of claim 10, wherein the microwell comprises an electro-wettable zone.

17. The device of claim 10, wherein the microwell comprises a chemically-modified zone.

18. The device of claim 10, wherein the microwell comprises a zone which exhibits hydrophobic and non-adsorptive properties with respect to the analytes.

19. The device of claim 10, wherein the microwell comprises a zone which exhibits hydrophobic and adsorptive properties with respect to analytes.

20. The device of claim 10, wherein the microwell and the intermediate electro-wettable site are shaped to enable the liquid sample to simultaneously contact the microwell and the intermediate electro-wettable site.

21. The device of claim 10, wherein the electro-wettable sites are at least partially nested.

22. The device of claim 10, wherein the electro-wettable sites are elliptically shaped.

23. The device of claim 10, wherein the device is a laminate comprising a non-conducting substrate.
